(19) United States
(12) Patent Application Publication
(10) Pub. No.: US 2009/0095892 A1
(43) Pub. Date: Apr. 16, 2009

(54) Encoder Error Determination

(75) Inventors: Ivor John Summers, Wotton-under-Edge (GB); Michael Homer, London (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge, Gloucestershire (GB)

(21) Appl. No.: 11/887,624

(22) PCT Filed: Apr. 25, 2006
(86) PCT No.: PCT/GB2006/001518

§ 371 Date: Oct. 2, 2007

(30) Foreign Application Priority Data
Apr. 26, 2005 (GB) 0508335.7

(51) Int. Cl. G01B 11/14; G01D 5/34

(52) U.S. Cl. 250/231.1; 356/614

(57) ABSTRACT

A rideheight sensing device is described for providing a measure of the separation between the readhead portion and the scale of an encoder. The rideheight sensing device comprises a rideheight sensor that is located at, or is attachable to, the readhead portion of an encoder. The temporary, or permanent, attachment of such a device to the readhead portion of an encoder is also described. In a preferred embodiment, a rotary encoder is described and the rideheight sensing device is used to measure the eccentricity thereof.

The present invention relates to the measurement of rideheight in position measurement encoders. In particular, the invention relates to a method and apparatus for determining any eccentricity errors in rotary encoder devices and the like.

Rotary encoders are known and typically comprise a ring that is rotatable relative to one or more readheads. The ring typically has a scale marked around its periphery that can be read by the associated readhead(s). Errors caused by eccentricity in such rotary encoder devices are manifested as errors in angular measurements which have a sinusoidal pattern having a period equal to one revolution of the encoder. Conventionally, the encoder is mounted to be as concentric as possible with the axis of rotation of the encoder.

It is known that the degree of eccentricity can be measured using a dial test indicator (DTI). The encoder and DTI are both mounted to a fixed reference surface (e.g. a bench) and the DTI is used to measure the displacement of an outer surface of the encoder ring as it is rotated. The encoder is adjusted until no (or very little) displacement of the encoder's surface is detected. Such a manual adjustment method requires time consuming setting up of the DTI on a support and manual reading of the DTI as the encoder is rotated. Furthermore, access to the encoder is often restricted making it impracticable to use a DTI.

According to a first aspect of the present invention, there is provided a rideheight sensing device for providing a measure of the separation between the readhead portion and the scale of an encoder, characterised in that said device comprises a rideheight sensor that is located at, or is attachable to, the readhead portion of an encoder.

The present invention thus provides a rideheight sensing device having a readhead sensor that may be permanently or temporarily located at the readhead portion of an encoder. When located at the readhead portion of the encoder, the device provides a indication of the separation or gap between the scale and the readhead portion (i.e. the rideheight). It is thus possible to use such apparatus to measure any variations in rideheight that occur as the readhead portion is passed along the scale.

As described in more detail below, a rideheight sensor of the present invention is advantageous in a number of encoder related applications. For example, locating the rideheight sensor at the readhead portion of a rotary encoder enables the separation between the scale and the readhead portion of such a rotary encoder to be measured as the scale is rotated relative to the readhead portion. Having a measure of the separation between the scale and the readhead portion at a plurality of different angular orientations allows the eccentricity of such a rotary encoder device to be determined.

Furthermore, locating the rideheight sensing device directly at the readhead portion rather than providing a measurement device that is external to the encoder enables a quicker, more compact and cheaper solution to measuring rideheight in encoder devices. In particular, the present invention overcomes the requirement to provide external dial test indicators (DTI) or the like when configuring or checking the configuration of encoder devices.

It should be noted that the present invention allows eccentricity to be measured. A separate technique for correcting any such eccentricity is disclosed in our co-pending International patent application (based on British patent application GB0508325.8 having applicant's case reference 650 GB) filed on the same day as this application. The technique described in GB0508325.8 does not require the removal of all the eccentricity of the encoder for measurement to take place. However, it does require the measurement of eccentricity of the encoder to enable correction of encoder angular measurements to take account of the eccentricity errors.

Advantageously, the rideheight sensor comprises a non-contact sensor. Preferably, the non-contact sensor comprises at least one of an optical, inductive, capacitive, magnetic and gas pressure sensor. It should be noted that although a non-contact sensor is preferred, a contact sensor could alternatively be provided.

Conveniently, the rideheight sensor generates an electrical signal indicative of the separation between the readhead portion and the scale. The signal may be generated continually thereby providing a continuous measure of rideheight as the readhead portion is passed along the scale. Alternatively, the electrical signal may only be generated when required; e.g. on request or when the readhead portion is located at any one or more positions relative to the scale.

Advantageously, the rideheight sensor comprises releasable attachment means that allow the sensor to be releasably attached to the readhead portion of an encoder. In this manner, the rideheight sensor can be secured to the readhead portion whenever rideheight is to be measured (e.g. when installing or calibrating an encoder). Once the necessary measurements have been taken, the sensor can be detached from the readhead portion.

As outlined in more detail below, the readhead portion of an encoder may comprise a readhead (i.e. a head comprising a scale reader for reading the scale of the encoder) and/or a readhead mounting bracket or a similar type of support suitable for retaining a readhead. In other words, the releasable attachment means may be arranged to attach the rideheight sensor directly to a readhead or to a support to which a readhead can also be attached.

The releasable attachment means preferably comprises a clip or similar fixing that permits rapid attachment and detachment of the rideheight sensor to the readhead portion. This enables the rideheight sensor to be quickly and simply installed without the time consuming set-up procedure required when using DTIs or other similar external devices.

Conveniently, the rideheight sensor is fixedly attachable to the readhead portion of an encoder. In other words, the sensor may be permanently attached to, or a integral part of, the readhead portion. In this manner, rideheight may be measured whenever necessary without the use of any additional apparatus. Encoder apparatus may thus be provided in which rideheight measurements can be taken continuously or whenever required.

Advantageously, a readhead for an encoder is provided that comprises a rideheight sensing device of the type described above and a scale reader. The scale reader is suitable for reading an associated scale to provide a measure of the relative lateral or angular movement between the readhead and the scale. The scale reader may comprise an incremental scale reader or an absolute scale reader. In this manner, the scale reader provides a measure of how much scale has passed the readhead and/or the absolute (lateral) position of the readhead relative to the scale.

Conveniently, the readhead comprises a combined sensor that incorporates the scale reader and the rideheight sensor. Such a sensor thus provides information about the relative lateral or angular movement between the readhead and the scale and also any variations in rideheight that occur as the scale passes the readhead. Providing such a combined sensor allows a compact readhead to be provided.

Advantageously, the combined sensor comprises a light source and at least two optical detectors, the readhead being arranged such that light can be passed from the light source to each of the two optical detectors via an associated encoder scale. For example, the light source may be arranged to illuminate the encoder scale with a beam of light. The optical detectors may then be arranged to receive any of that light which is reflected from, or transmitted by, the scale.

Preferably, said at least two optical detectors are spatially separated and the rideheight sensor provides a measure of the separation between the scale and the readhead from the relative intensity of light received by the optical detectors.

Instead of providing a readhead having a combined scale reader and rideheight sensor, the readhead may incorporate a scale reader that is separate to the rideheight sensing device. In such a case, the scale reader is preferably located adjacent to the rideheight sensing device.

Encoder apparatus may also be advantageously provided which incorporates the above described readhead. Encoder apparatus comprising a readhead with an integral rideheight sensing device is thus provided which can produce a measure of rideheight whenever required.

Encoder apparatus may also be provided that comprises a readhead portion and a rideheight sensing device that is releasably attachable to the readhead portion. In other words, the encoder apparatus may comprise a rideheight sensing device that can be attached to the readhead portion whenever a measure of rideheight is required.

Advantageously, the readhead portion of the encoder comprises a readhead support structure (e.g. a bracket or similar support), wherein each of the rideheight sensing device and a readhead are releasable attachable to the readhead support structure. The readhead support structure may be arranged to retain any one or both of a readhead and rideheight measurement device at any one time. In a preferred embodiment, the readhead may be detached from the readhead support structure and replaced by the rideheight sensing device whenever rideheight is to be measured.

Alternatively, the readhead portion of the encoder conveniently comprises a readhead, the rideheight sensor being releasably attachable to the readhead. In other words, the rideheight sensing device may be attached (e.g. clipped) onto the readhead of an encoder whenever rideheight measurements are required.

The encoder may also comprise a scale, the readhead portion being moveable relative to the scale. For example, a linear encoder may be conveniently provided in which the encoder scale is linearly translatable relative to the readhead portion.

A rotary encoder may also be provided in which the scale is rotatably mounted relative to the readhead portion. Advantageously, the scale comprises a ring comprising a series of peripheral scale markings. Such markings are preferably provided on the edge of the ring.

Advantageously, the apparatus comprises eccentricity measurement means, the eccentricity measurement means being arranged to determine eccentricity from the measured separation between the scale and the readhead portion as a function of the angular orientation of the scale relative to the readhead portion.

According to a second aspect of the invention, encoder apparatus comprises an encoder scale that is moveable relative to a readhead, characterised in that said readhead comprises an integral rideheight sensor for measuring any variation in the rideheight of the readhead as said readhead is passed along the encoder scale.

Advantageously, the encoder apparatus is rotary encoder apparatus, the rideheight sensor being arranged to measure any variation in the rideheight of the readhead as said readhead is rotated relative to the encoder scale. Conveniently, eccentricity measurement means are provided to determine eccentricity from the variation in rideheight as a function of the angular orientation of the encoder scale relative to the readhead portion.

According to a third aspect of the invention, rotary encoder apparatus comprises an encoder scale that is rotatably mounted relative to a readhead portion, wherein a rideheight sensor is releasably attachable to the readhead portion, said rideheight sensor being arranged to measure, when attached to the readhead portion, any variation in the separation between the readhead portion and the encoder scale.

According to a fourth aspect of the invention, rotary encoder apparatus comprises an encoder scale rotatably mounted relative to a single readhead, wherein the apparatus comprises integral means for measuring eccentricity of the encoder scale.

According to a fifth aspect of the invention, a rideheight measurement method comprises the step of (i) assessing the separation between the readhead portion and the scale of an encoder, characterised in that step (i) comprises using a rideheight sensor located at the readhead portion of said encoder. Advantageously, the method comprises the step of measuring any variation in the separation between the readhead portion and the scale as the readhead portion is passed along the scale. Conveniently, such a step comprises the use of a non-contact sensor.

Advantageously, the method is applied to a rotary encoder. Preferably, the method further comprises the step of determining the eccentricity of said rotary encoder from the measured separation between the readhead portion and the scale. The method may also advantageously comprise the step of attaching a rideheight sensor to the readhead portion of an encoder.

The present invention can thus be seen to provide a rotary encoder reader having means for measuring eccentricity of an encoder scale member (e.g. an encoder scale) and means for measuring angular movement between the encoder reader and scale member. Preferably the encoder reader has permanently the said means for measuring eccentricity. Alternatively the encoder reader has temporarily the said means for measuring eccentricity. Preferably the means for measuring eccentricity comprises means for measuring the gap between the reader and the encoder scale member.

The means for measuring angular movement may comprise elements of the reader (e.g. optical elements) used for the angular measurement (e.g. incremental measurement) and these elements comprise the means for measuring eccentricity also. Preferably the encoder reader has integral means for measuring eccentricity as substantially as described herein.

As outlined above, the invention also extends to an eccentricity determination device, an encoder reader and a mounting which accepts both the device and the reader, so that the device and reader are interchangeable. The invention also extends to various method of determining eccentricity of an encoder and then exchanging the device used to determine the eccentricity with a conventional encoder reader.

The invention will now be described, by way of example only, with reference to the accompanying drawings in which:

FIG. 1 shows a first embodiment of the invention;

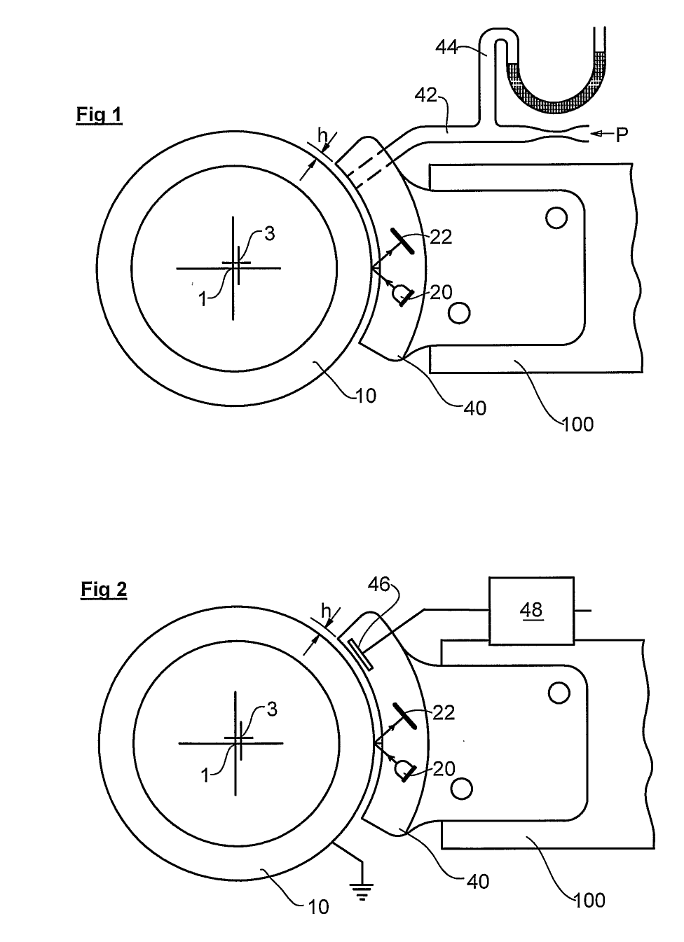

FIG. 2 shows a second embodiment of the invention;

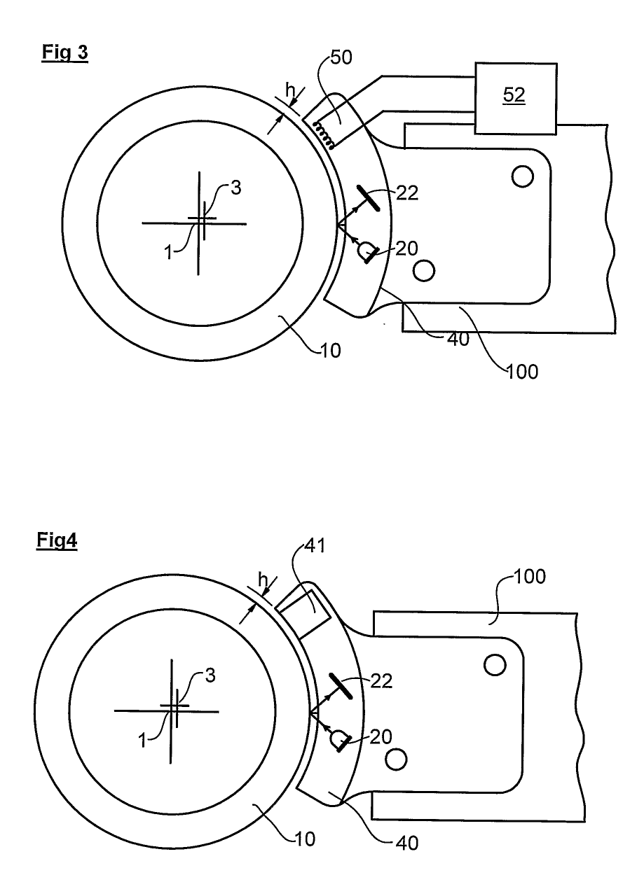

FIG. 3 shows a third embodiment of the invention;

FIGS. 4a and b show a fourth embodiment of the invention;

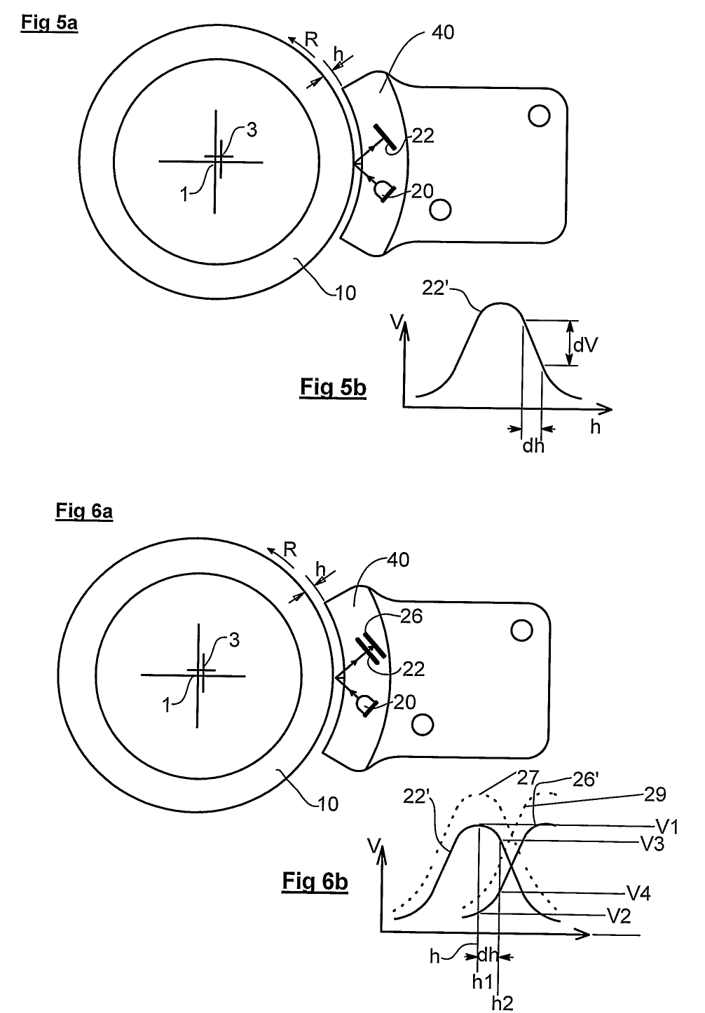

FIGS. 5a and b show a fifth embodiment of the invention;

FIG. 6 shows a sixth embodiment of the invention; and

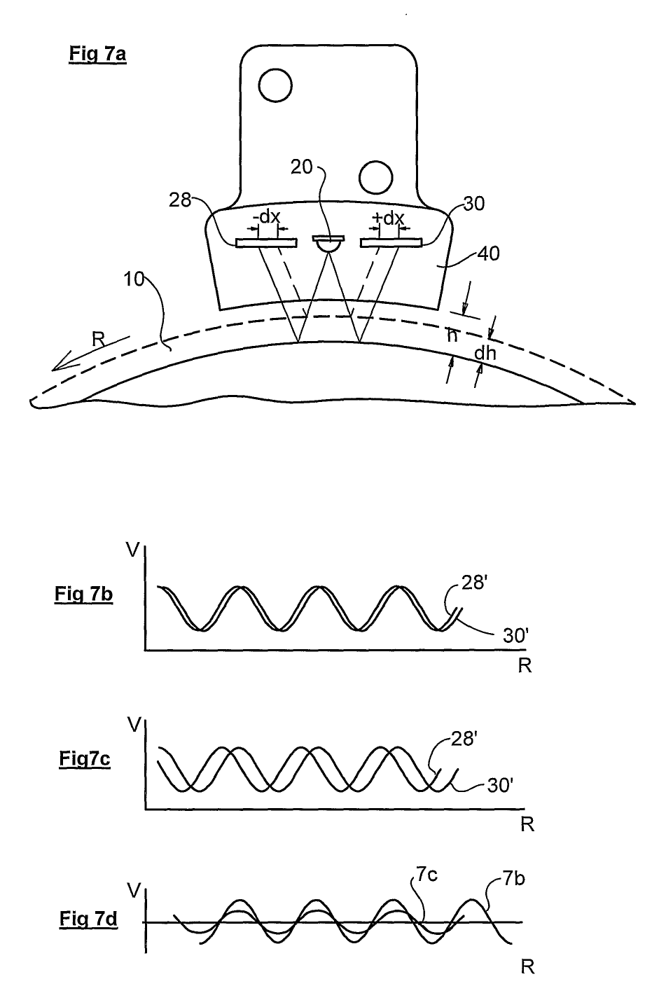

FIGS. 7a,b,c and d show a seventh embodiment of the invention.

FIG. 1 shows an encoder scale 10 and a fixed encoder reader 40 (also known as a readhead) which is capable of reading markings on the encoder scale 10 in a conventional manner for determining the degree of rotation of the encoder scale about the centre of rotation 3. In this example the centre of rotation 3 does not coincide with the geometric centre of the encoder 1. So, when rotated the gap h will vary due to the apparent eccentricity of the encoder scale. This eccentricity will cause errors in the angular measurement determined by the readhead 40.

If the gap h can be measured, the error caused by the eccentricity can be determined. The error can then be removed (e.g. by adjusting the scale mount) or appropriate compensation can be applied. A suitable method of correction is described in our co-pending International (PCT) patent application that claims priority from British patent application GB0508325.8 (agents ref. 650 GB).

In the embodiment shown in FIG. 1 pressurised gas P is fed into conduit 42 at a fixed supply pressure. The escape of the gas through gap h will vary as the gap changes. The pressure change can be measured by a pressure sensor 44, in this case a u-tube manometer. Thus it can be seen that any change in h can be determined because such a change will cause a corresponding pressure change in the sensor 44. The pressure change can be calibrated to give an absolute value for h.

In the embodiment shown in FIG. 2 the gap h is determined by means of a capacitative element 46 which changes capacitance as the gap h varies. A capacitance sensor circuit 48 is used to measure the capacitance and hence the gap h.

In the embodiment shown in FIG. 3 the gap h alters the inductance of coil 50. A tuned circuit 52 is used to determine the gap h. In this embodiment the encoder scale 10 is preferably metallic and magnetic. Other techniques for detecting the change in the inductance of the coil, such as its loss factor are known and may be used.

The embodiment shown in FIG. 4 shows a range finding device 41 which is used to determine gap h. In this embodiment a range finding device is used which produces a beam of light e.g. a beam of infra-red radiation. The time taken for the light to return to the device 41 is determined so that a calculation of the gap h can be made. Alternatively the range finding device can be a focusing device e.g. a CCD passive focusing system can be employed which will determine the gap h by means of image processing. A determination of dimension h can be made by comparing the difference in light intensity of the encoder scale markings across the CCD. Once a focused image having sudden differences in light intensity is established the degree of adjustment of the device 41 required to produce the focused image can be used as a measure of the gap h.

Another alternative is to use an auto focus device which utilises a pinhole. The degree of adjustment required to focus an image from the encoder scale through a pinhole is used to determine gap h. A photodetector is used to measure the amount of light passing through the pinhole and this gives a measure of focus and hence a measure of the gap h.

In embodiments shown in FIGS. 1-4 the eccentricity determining devices 42,44; 46,48; 50,52; and 41 are illustrated as integral parts of the readhead and are thus permanently attached thereto. However, it is possible that these gap sensing elements may be temporarily attached to the readhead 40; for example using clips or other types of releasable fastening. When attached, the eccentricity determination devices can be used to determine eccentricity errors during relative movement of the device and the encoder scale. If the eccentricity determination devices are only temporarily attached, they may be removed when no longer required to save space.

It is also possible that the readhead 40 and eccentricity determining device can be discrete interchangeable units. In such an example, the two units may have a common mounting bracket or area 100 which will accept both units in turn. Eccentricity will be measured first using an eccentricity determination device as described above, then the device will be removed and replaced by a readhead. This modification provides a simple spacing-saving arrangement which can be used for multiple encoder/readhead installations with little additional cost.

For ease of illustration the eccentricity measuring devices in FIGS. 1-4 are shown distant from the angular measurement device 20,22. In practice, the eccentricity measuring devices will typically be much closer to the angular measurement device 20,22 so that a better representation of the eccentricity at the angular measurement device will be achieved.

FIG. 5a shows an embodiment of a readhead having means for angular measurement adapted to measure gap h. In use, light from a source 20 reflects from the encoder scale and falls on a photodetector 22. The encoder scale is arranged such that reflected light causes the formation of light and dark patterns (interference fringes) on the associated photodetector 22. As the encoder moves in the direction R, this fringe pattern will change and the change in intensity can be used to determine the degree of angular rotation R. The signal produced by the photodetector as a result of the light intensity will vary in an approximately bell shaped curve dependent on the gap h between the encoder scale 10 and the readhead 40. The arrangement of the signal processing of this signal can be adapted such that the amplitude of the signal from the photodetector can be used to determine the gap h, and hence eccentricity when h changes.

FIG. 5b comprises a graph having a line 22′ which shows the detected signal strength (voltage) V against gap or rideheight h. The change in signal strength dV caused by a change dh in the rideheight h during rotation R of the encoder can be measured. If dh is arranged such that it occurs at the steepest part of the bell curve, then dV will be very pronounced for small dh, as shown. So dV is locally proportional to dh.

FIG. 6a shows an embodiment which is a modification of the embodiment shown in FIG. 5a. In this embodiment there are two photodetectors 22 and 26 one of which is displaced relative to the other. Consequently, the signal strength will be different at each of these photodetectors.

FIG. 6b shows the amplitude in volts (V) of two signals 22′ and 26′ from the photodetectors 22 and 26 when h takes the values h1 and h2 (where dh equals h1-h2). When h equals h1, signals 22′ and 26′ take the values V1 and V2 respectively. When h equals h2, signals 22′ and 26′ taken the values V3 and V4 respectively. It can be seen that varying the gap by dh (i.e. changing the gap from h1 to h2) causes the ratio of the two signals 22′ and 26′ to change from V1-V2 to V3-V4.

Monitoring the ratio of two signal, rather than the absolute amplitude of a single signal, provides greater resistance to the effects of external noise. If the signals 22′ and 26′ increase or decrease (an increase is shown by dotted lines 27 and 29) due to external influences e.g. contamination, stray light or variation in the properties of the graduations being sensed, then the two signals 22′ and 26′ will do so together at the same rate, as shown. Consequently, the ratios mentioned above will remain approximately the same as the two signals 22′ and 26′ change in amplitude together. So, in the embodiment shown in FIG. 6a the determination of dh is unaffected by changes in signal strength 22′ and 26′ caused by changes, e.g. in general light intensity, at the readhead. It is thus possible for h to be at any position on the graph shown in FIG. 6b. However, the device is preferably arranged such that the gradients of the signals 22′ and 26′ are different around the gap h of interest thereby maximising the change in the ratio of the signals 22′ and 26′ as the gap varies.

FIG. 7a shows another embodiment of the invention wherein the optical arrangement of the readhead 40 conventionally used for angular measurement is adapted to also measure eccentricity. In this embodiment, two opposed photodetector gratings 28 and 30 are used on each side of a light source 20. During incremental measurement these two gratings measure a sinusoidal change in light intensity as described above. Each photodetector grating will measure the same incremental change as rotation of the encoder relative to the readhead takes place, provided that the gap h does not change. If the gap h does change e.g. by dh as denoted by the dotted line, then the phase of the light at each photodetector will shift by opposing amounts −dx and +dx. If such a shift occurs then the amplitude of the subtracted signals from the photodetectors 28 and 30 will change as the gap h changes. Thus a change in h can be measured as a function of the change in the subtracted signals.

FIG. 7b shows the two incremental signals 28′ and 30′ from the photodetectors 28 and 30 at gap h as the encoder scale rotates. FIG. 7c shows the two signals 28′ and 30′ when the gap has changed by dh. In this instance the phase relationship of the signals has been altered because the distance h has changed. FIG. 7d shows the signal 28′ subtracted from signal 30′. The line 7b shows the signal 28′ of FIG. 7b subtracted from the signal 30′ of FIG. 7b. The line 7c shows the signal 28′ of FIG. 7c subtracted from the signal 30′ f FIG. 7c. The amplitude of these signals 7b and 7c is dependent on the phase relationship between signals 28′ and 30′, and thus the dimension h. Other techniques of extracting the relative phase of the signals independent of their magnitude, are known and may be used to derive the height variation dh.

It is possible also to output signals 28′ and 30′ directly to a counter or similar circuit (not shown) which can determine an apparent angular position for each photodetector 28 and 30. These apparent positions will change as dh changes as a result of the effects mentioned above so the difference in the apparent angular positions derived from the signals 28′ and 30′ can be used to determine dh.

In each of the embodiments described above incremental measurement of angular rotation has been illustrated as taking place on an outer peripheral surface of an encoder scale 10. However, it is possible that radial markings can be used and eccentricity can be measured from any surface which extends parallel to the axis of rotation, or by reference to features on a surface perpendicular to the axis. Also, it is possible that encoder scale 10 will be stationary whilst readhead 40 moves or, both may rotate. Absolute angular measurement can be used as an alternative or as well as the incremental measurement described above and illustrated. Optical angular measurement is illustrated, however, such measurement could be other than optical, e.g. magnetic or capacitive. Furthermore, the rideheight sensing devices described herein may also be used to measure rideheight in non-rotary encoder devices. For example, such devices may be used to measure the rideheight of readheads or the like in linear encoder systems.

1-32. (canceled)

33. An encoder device comprising;
a readhead portion for reading an associated scale; and
a rideheight sensing device for providing a measure of the separation between the readhead portion and the scale;
wherein the rideheight sensing device comprises a rideheight sensor located at the readhead portion.

34. A device according to claim 33 wherein the rideheight sensor generates an electrical signal indicative of the separation between the readhead portion and the associated scale, the rideheight sensor comprising at least one of an optical, inductive, capacitive, magnetic and gas pressure sensor.

35. A device according to claim 33 wherein the readhead portion comprises a combined sensor, the combined sensor comprising the rideheight sensor and a scale reader for reading the associated scale.

36. A device according to claim 35 wherein the combined sensor comprises a light source and at least two optical detectors, the readhead being arranged such that light can be passed from the light source to each of the two optical detectors via an associated scale.

37. A device according to claim 36 wherein the at least two optical detectors are spatially separated and the rideheight sensor provides a measure of the separation between the associated scale and the readhead from the relative intensity of light received by the at least two optical detectors.

38. A device according to claim 33 wherein the readhead portion comprises a scale reader for reading the associated scale, wherein the scale reader is located adjacent to the rideheight sensor.

39. A device according to claim 33 comprising a scale, wherein the readhead portion is moveable relative to the scale.

40. A device according to claim 39 wherein the scale is rotatably mounted relative to the readhead portion.

41. A device according to claim 40 wherein the scale comprises a ring comprising a series of peripheral scale markings.

42. A device according to claim 40 comprising an eccentricity measurement device, the eccentricity measurement device being arranged to calculate eccentricity from the measured separation between the scale and the readhead portion as a function of the angular orientation of the scale relative to the readhead portion.

43. A rideheight sensing device for providing a measure of the separation between the readhead portion and the scale of an encoder, wherein the device comprises a rideheight sensor that is attachable to the readhead portion of the encoder.

44. A device according to claim 43 wherein the rideheight sensor, when attached to the readhead portion of an encoder, generates an electrical signal indicative of the separation between the readhead portion and the scale, wherein the rideheight sensor comprises a non-contact sensor comprising at least one of an optical, inductive, capacitive, magnetic and gas pressure sensor.

45. A device according to claim 43 wherein the rideheight sensor comprises a releasable attachment mechanism, the releasable attachment mechanism allowing the rideheight sensor to be releasably attached to the readhead portion of an encoder.

46. Encoder apparatus comprising a rideheight sensing device according to claim 43 and a readhead portion, wherein the rideheight sensor of the rideheight sensing device is releasably attachable to the readhead portion.

47. An apparatus according to claim 46 comprising a readhead for reading an associated scale, wherein the readhead portion comprises a readhead support structure, wherein each of the rideheight sensor of the rideheight sensing device and the readhead are releasably attachable to the readhead support structure.

48. An apparatus according to claim 46 wherein the readhead portion comprises a readhead for reading an associated scale, wherein the rideheight sensor is directly attachable to the readhead.

49. An apparatus according to claim 46 comprising a scale, wherein the readhead portion is moveable relative to the scale.

50. An apparatus according to claim 49 wherein the scale comprises a ring comprising a series of peripheral scale markings, the scale being rotatably mounted relative to the readhead portion.

51. An apparatus according claim 50 comprising an eccentricity measurement device, the eccentricity measurement device being arranged to calculate eccentricity from the measured separation between the scale and the readhead portion as a function of the angular orientation of the scale relative to the readhead portion.

52. Encoder apparatus comprising an encoder scale that is moveable relative to a readhead, wherein the readhead comprises an integral rideheight sensor for measuring any variation in the rideheight of the readhead as the readhead is passed along the encoder scale.

53. Apparatus according to claim 52 wherein the encoder apparatus is rotary encoder apparatus, the rideheight sensor being arranged to measure any variation in the rideheight of the readhead as the readhead is rotated relative to the encoder scale, wherein an eccentricity measurement device is provided to determine the eccentricity of the rotary encoder apparatus from the variation in rideheight as a function of the angular orientation of the encoder scale relative to the readhead.

54. Rotary encoder apparatus comprising an encoder scale that is rotatably mounted relative to a readhead portion, wherein a rideheight sensor is releasably attachable to the readhead portion, the rideheight sensor being arranged to measure, when attached to the readhead portion, any variation in the separation between the readhead portion and the encoder scale.

55. A rideheight measurement method comprising the step of (i) assessing the separation between the readhead portion and the scale of an encoder, wherein step (i) comprises using a rideheight sensor located at the readhead portion of the encoder.

56. A method according to claim 55 comprising the step of measuring any variation in the separation between the readhead portion and the scale as the readhead portion is passed along the scale.

57. A method according to claim 56 wherein the encoder is a rotary encoder, wherein the method further comprises the step of determining the eccentricity of the rotary encoder from the measured separation between the readhead portion and the scale.
